(19) United States
(12) Patent Application Publication
(10) Pub. No.: US 2014/0320510 A1
(43) Pub. Date: Oct. 30, 2014

(54) DETECTION OF A HOT-PLUG EVENT OF COUPLING A TARGET DISPLAY IN A STANDBY MODE TO A SOURCE DEVICE TO ENABLE AUTOMATIC TRANSITIONING OF THE TARGET DISPLAY TO AN ACTIVE MODE OF OPERATION THEREOF

(71) Applicant: NVIDIA Corporation, Santa Clara, CA (US)

(72) Inventors: Sathiyaraj Ramachandran, Tuticorin (IN); Shanker Sounderraj, Vellore (IN); Surendhran Sivalingam, Coimbatore (IN)

(73) Assignee: NVIDIA Corporation, Santa Clara, CA (US)

(21) Appl. No.: 13/869,938

(22) Filed: Apr. 24, 2013

(51) Int. Cl. G09G 5/00

(52) U.S. Cl. CPC G09G 5/006
USPC 345/520

(57) ABSTRACT

A method includes detecting, through a processor of a source device and/or a processor of a target display communicatively coupled to a memory, a hot-plug event indicating coupling of the target display to the source device without shutting down both the source device and the target display when the target display is in a standby mode of operation thereof. The method also includes transitioning, through the processor of the source device and/or the processor of the target display, the target display from the standby mode of operation to an active mode of operation thereof based on a control signal from the processor of the source device and/or the processor of the target display following the detection of the hot-plug event. The active mode is associated with a higher power level than the standby mode.

### FIELD OF TECHNOLOGY

This disclosure relates generally to display devices and, more particularly, to a method, a device and/or a system of detection of a hot-plug event of coupling a target display in a standby mode to a source device to enable automatic transitioning of the target display to an active mode of operation thereof.

### BACKGROUND

A display coupled to a source data processing device (e.g., a personal computer, a tablet, a laptop computer, a server, a notebook computer, a netbook, a mobile phone) may be in a standby mode of operation (e.g., associated with minimum power/resource utilization) thereof. A user intervention may be required to transition the display into an active mode of operation thereof by way of pressing a physical button provided on the display. When the user is at the source data processing device and the display is far off from the source data processing device, the requirement to press the physical button at a location of the display may significantly inconvenience the user.

### SUMMARY

Disclosed are a method, a device and/or a system of detection of a hot-plug event of coupling a target display in a standby mode to a source device to enable automatic transitioning of the target display to an active mode of operation thereof.

In one aspect, a method includes detecting, through a processor of a source device and/or a processor of a target display communicatively coupled to a memory, a hot-plug event indicating coupling of the target display to the source device without shutting down both the source device and the target display when the target display is in a standby mode of operation thereof. The method also includes transitioning, through the processor of the source device and/or the processor of the target display, the target display from the standby mode of operation to an active mode of operation thereof based on a control signal from the processor of the source device and/or the processor of the target display following the detection of the hot-plug event. The active mode is associated with a higher power level than the standby mode.

In another aspect, a non-transitory medium, readable through a source device and/or a target display communicatively coupled to the source device and including instructions embodied therein that are executable through the source device and/or the target display, is disclosed. The non-transitory medium includes instructions to detect, through a processor of the source device and/or a processor of the target display communicatively coupled to a memory, a hot-plug event indicating coupling of the target display to the source device without shutting down both the source device and the target display when the target display is in a standby mode of operation thereof. Further, the non-transitory medium includes instructions to transition, through the processor of the source device and/or the processor of the target display, the target display from the standby mode of operation to an active mode of operation thereof based on a control signal from the processor of the source device and/or the processor of the target display following the detection of the hot-plug event. The active mode is associated with a higher power level than the standby mode.

In yet another aspect, a system includes a display, and a source device including a processor communicatively coupled to a memory. The processor is configured to execute instructions to detect a hot-plug event indicating coupling of the display to the source device without shutting down both the source device and the display when the display is in a standby mode of operation thereof, and to transition the display from the standby mode of operation to an active mode of operation thereof based on a control signal from the processor following the detection of the hot-plug event. The active mode is associated with a higher power level than the standby mode.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a display system including a source device communicatively coupled to a target display, according to one or more embodiments.

FIG. 2 is a schematic view of an example High Definition Media Interface (HDMI) interface utilized to couple the source device and the target display of FIG. 1.

FIG. 3 is a schematic view of interaction between a driver component and a processor of the source device of FIG. 1, according to one or more embodiments.

FIG. 4 is a process flow diagram detailing the operations involved in detection of a hot-plug event of coupling the target display in a standby mode to the source device of FIG. 1 to enable automatic transitioning of the target display to an active mode of operation thereof, according to one or more embodiments.

Other features of the present embodiments will be apparent from the accompanying drawings and from the detailed description that follows.

### DETAILED DESCRIPTION

Example embodiments, as described below, may be used to provide a method, a system and/or a device of detection of a hot-plug event of coupling a target display in a standby mode to a source device to enable automatic transitioning of the target display to an active mode of operation thereof. Although the present embodiments have been described with reference to specific example embodiments, it will be evident that various modifications and changes may be made to these embodiments without departing from the broader spirit and scope of the various embodiments.

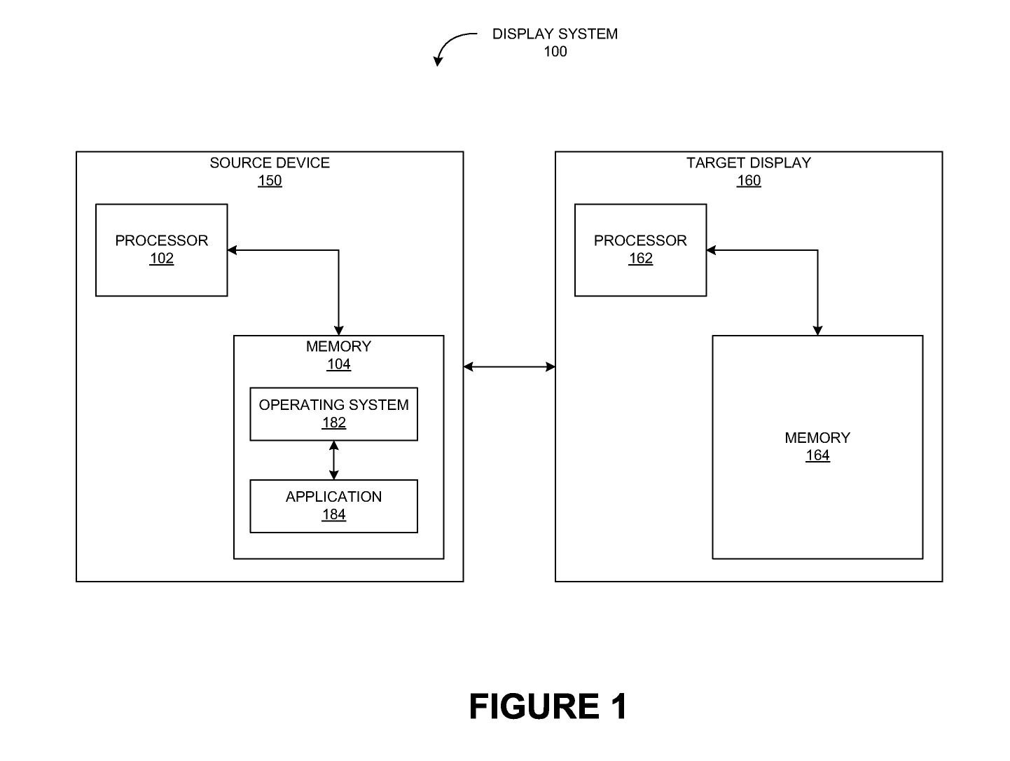

FIG. 1 shows a display system 100 including a source device 150 communicatively coupled to a target display 160, according to one or more embodiments. In one or more embodiments, target display 160 may be a Liquid Crystal Display (LCD), a Cathode Ray Tube (CRT) monitor; target display 160 may, for example, be part of a television set. In one or more embodiments, source device 150 may be a data processing device such as a personal computer, a server, a laptop computer, a notebook computer, a netbook and a mobile device (e.g., a mobile phone). Other forms of source device 150 and target display 160 are within the scope of the exemplary embodiments discussed herein.

In one or more embodiments, source device 150 may include a processor 102 (e.g. a Central Processing Unit (CPU), a Graphics Processing Unit (GPU), a microprocessor, a microcontroller) communicatively coupled to a memory 104 (e.g. a volatile memory and/or a non-volatile memory); memory 104 may include storage locations configured to be addressable through processor 102. In one or more embodiments, source device 150 may be coupled to target display 160 through wired (e.g., through a High Definition Media Interface (HDMI) cable) or wireless (e.g., Wi-Fi™, Bluetooth®) means.

In a typical scenario, target display 160 may be in a standby mode of low power consumption (e.g., minimal resource utilization therein) thereof. Upon coupling of source device 150 to target display 160, for example through an HDMI cable, an appropriate button on target display 160 may have to be pressed in order to wake up target display 160 into an active mode of operation thereof. It is obvious that the active mode of operation may be associated with a power level that is higher than the standby mode of operation; the active mode of operation may signify a normal mode of operation of target display 160.

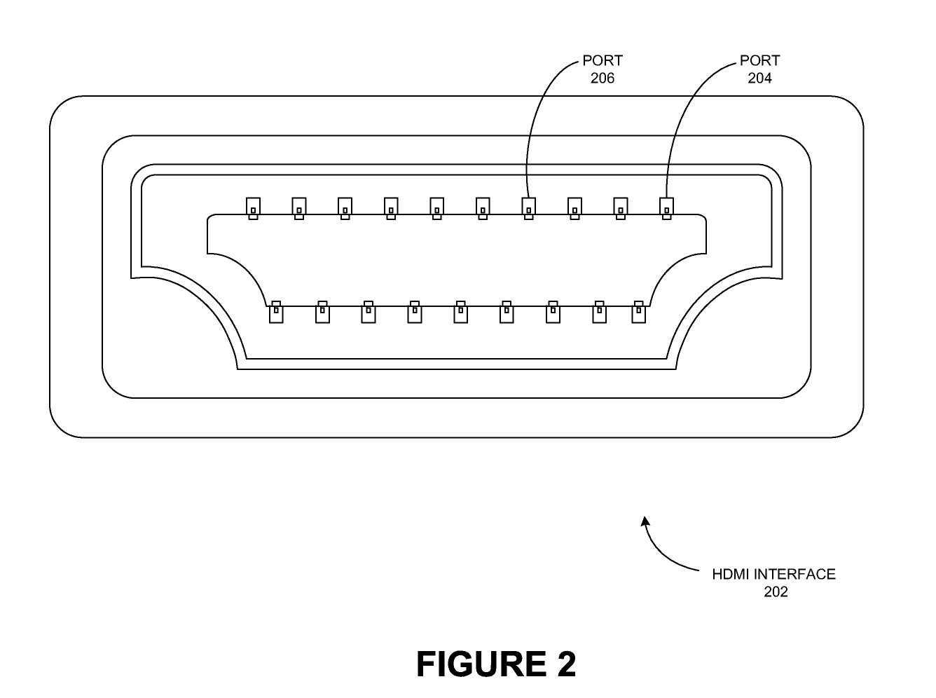

In the case of utilization of an HDMI cable to couple source device 150 to target display 160, it is obvious that an HDMI interface (e.g., a HDMI port) may be provided in each of source device 150 and target display 160. FIG. 2 shows an example HDMI interface 202. HDMI interface 202 may have a port 204 associated with detection of a hot-plug event. Here, the hot-plug event may indicate a connection of target display 160 to source device 150 without shutting down source device 150 and target display 160. Target display 160 may be in a standby mode of operation thereof for which a port 206 may serve as a control port. Control of the standby mode may be accomplished from source device 150 and/or target display through port 206 based on a control protocol such as Consumer Electronics Control (CEC).

In one or more embodiments, source device 150 may have a driver component (e.g., a set of instructions) configured to enable processor 102 automatically detect the hot-plug event of coupling target display 160 thereto through HDMI interface 202 when target display 160 is in the standby mode of operation thereof. For example, processor 102 may periodically poll HDMI interface 202 for a status thereof. Upon detecting the hot-plug event by way of HDMI interface 202, processor 102 may be configured to transmit a control signal (e.g., based on an interrupt generated through processor 102 that interrupts power supply during standby mode and switches on power supply from circuitry associated with the active mode of operation) related to transitioning target display 160 into an active mode of operation thereof through HDMI interface 202 (e.g., through controlling port 206). Thus, target display 160 may be configured to wake up into the active mode of operation thereof without a requirement of a user to press a button on target display 160 therefor.

It should be noted that the detection of the hot-plug event and/or the transitioning of target display 160 from the standby mode to the active mode thereof may not be required to be solely performed at source device 150. Target display 160 may also have intelligence provided therein, whereby detection of the hot-plug event and/or the transitioning thereof into the active mode may be detected through a processor 162 (e.g., a CPU, a microcontroller, a microprocessor) communicatively coupled to a memory 164 (e.g., a volatile and/or a non-volatile memory, a cache) of target display 160. FIG. 1 shows target display 160 as having processor 162 and memory 164. It is obvious now that the operations discussed above may be performed through source device 150 and/or target display 160. Further, it is obvious that target display 160 may not require processor 162 and memory 164 if all processing discussed above is performed through source device 150.

In the case of source device 150 and target display 160 being wirelessly coupled to one another, source device 150 and target display 160 may have appropriate transceivers/transmitters/receivers associated therewith. In the case of detection through source device 150, data related to the hot-plug event may be wirelessly communicated to source device 150. Source device 150 may then wake-up target display 160 through wireless transmission of the control signal discussed above.

With regard to the wired and wireless communication, it should be noted that other specific forms of wired and wireless communication other than the examples mentioned above are within the scope of the exemplary embodiments discussed herein.

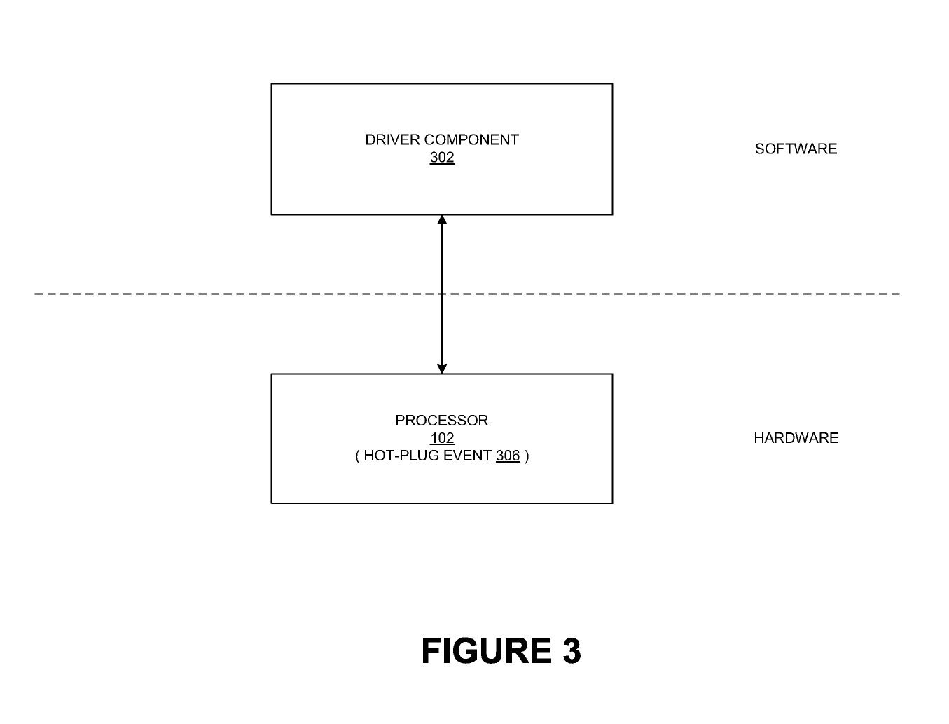

FIG. 3 shows interaction between a driver component 302 and processor 102 of source device 150 (or, processor 162 of target display 160), according to one or more embodiments. In one or more embodiments, as soon as source device 150 and target display 160 in the standby mode are coupled to each other, driver component 302 may initiate detection of hot-plug event 306 associated therewith through processor 102. In one or more embodiments, upon the detection of hot-plug event 306, processor 102 may be configured to transmit a control signal related to transitioning target display 160 into the active mode of operation thereof.

It should be noted that the CEC protocol-based control and the utilization of HDMI interface 202 discussed above are merely for example purposes. Other forms of display interfaces such as Digital Visual Interface (DVI), DisplayPort and Video Graphics Array (VGA) are within the scope of the exemplary embodiments discussed herein.

Further, it should be noted that driver component 302 discussed above may be associated with processor 102, processor 162 and/or target display 160. Instructions associated with driver component 302 may be packaged with an operating system 182 executing on source device 150 (see FIG. 1) and/or an application 184 (see FIG. 1) executing on source device 150. Said instructions may also be made available on a non-transitory medium (e.g., a Compact Disc (CD), a Digital Video Disc (DVD), a hard drive; appropriate instructions may be downloaded to the hard drive) readable through source device 150 and/or target display 160. All reasonable variations are within the scope of the exemplary embodiments discussed herein.

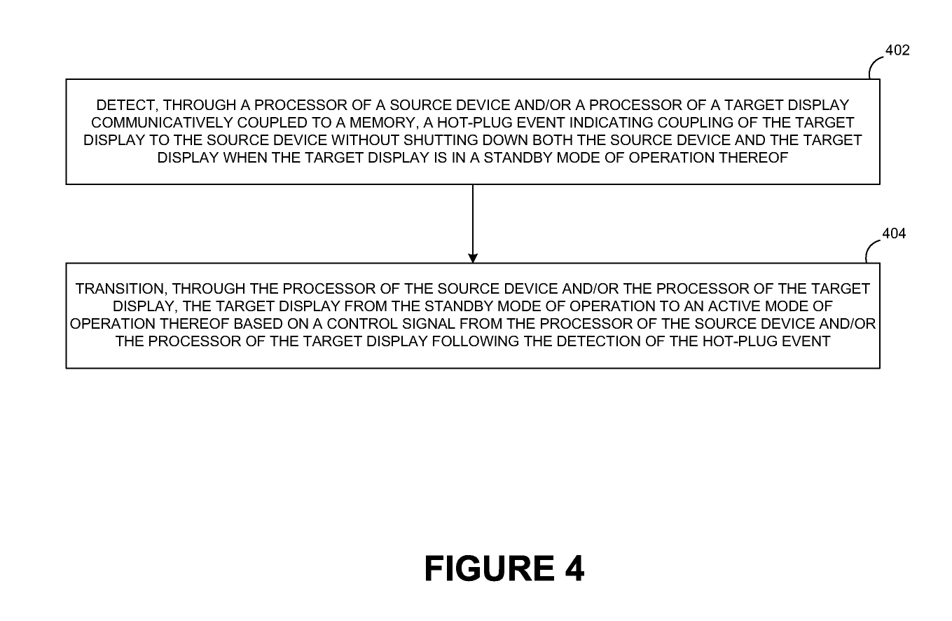

FIG. 4 shows a process flow diagram detailing the operations involved in detection of a hot-plug event of coupling target display 160 in a standby mode to source device 150 to enable automatic transitioning of target display 160 to an active mode of operation thereof, according to one or more embodiments. In one or more embodiments, operation 402 may involve detecting, through processor 102 and/or processor 162, a hot-plug event indicating coupling of target display 160 to source device 150 without shutting down both source device 150 and target display 160 when target display 160 is in a standby mode of operation thereof. In one or more embodiments, operation 404 may then involve transitioning, through processor 102 and/or processor 162, target display 160 from the standby mode of operation to an active mode of operation thereof based on a control signal from processor 102 and/or processor 162 following the detection of the hot-plug event. In one or more embodiments, the active mode may be associated with a higher power level than the standby mode.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., source device 150, target display 160). Accordingly, the specification and drawings are to be regarded in an illustrative rather than a restrictive sense.

What is claimed is:

1. A method comprising:
detecting, through at least one of a processor of a source device and a processor of a target display communicatively coupled to a memory, a hot-plug event indicating coupling of the target display to the source device without shutting down both the source device and the target display when the target display is in a standby mode of operation thereof; and
transitioning, through the at least one of the processor of the source device and the processor of the target display, the target display from the standby mode of operation to an active mode of operation thereof based on a control signal from the at least one of the processor of the source device and the processor of the target display following the detection of the hot-plug event, the active mode being associated with a higher power level than the standby mode.

2. The method of claim 1, comprising one of: wirelessly coupling the target display to the source device and coupling the target display to the source device through wired means.

3. The method of claim 2, wherein when the target display is coupled to the source device through the wired means, the method further comprises:
utilizing a control port of a display interface involved in the coupling to detect the hot-plug event; and
utilizing another control port of the display interface to transition the target display from the standby mode to the active mode based on a control protocol.

4. The method of claim 1, comprising enabling the detection of the hot-plug event and the transitioning of the target display from the standby mode to the active mode through a driver component associated with at least one of: the processor of the source device, the processor of the target display and the target display.

5. The method of claim 4, comprising providing the driver component through at least one of: packaging the driver component with an operating system configured to execute on the source device and packaging the driver component with an application configured to execute on the source device.

6. The method of claim 3, wherein at least one of:
the source device is one of a computing device and a mobile device,
the target display is one of a Liquid Crystal Display (LCD) and a computing device including the LCD, and
the control protocol is Consumer Electronics Control (CEC)-based.

7. The method of claim 3, further comprising periodically polling, through the at least one of the processor of the source device and the processor of the target display, the display interface for a status thereof to enable the detection of the hot-plug event.

8. A non-transitory medium, readable through at least one of a source device and a target display communicatively coupled to the source device and including instructions embodied therein that are executable through the at least one of the source device and the target display, comprising:
instructions to detect, through at least one of a processor of the source device and a processor of the target display communicatively coupled to a memory, a hot-plug event indicating coupling of the target display to the source device without shutting down both the source device and the target display when the target display is in a standby mode of operation thereof; and
instructions to transition, through the at least one of the processor of the source device and the processor of the target display, the target display from the standby mode of operation to an active mode of operation thereof based on a control signal from the at least one of the processor of the source device and the processor of the target display following the detection of the hot-plug event, the active mode being associated with a higher power level than the standby mode.

9. The non-transitory medium of claim 8, comprising instructions compatible with the target display being one of: wirelessly coupled to the source device and being coupled to the source device through wired means.

10. The non-transitory medium of claim 9, wherein when the target display is coupled to the source device through the wired means, the non-transitory medium further comprises:
instructions to utilize a control port of a display interface involved in the coupling to detect the hot-plug event; and
instructions to utilize another control port of the display interface to transition the target display from the standby mode to the active mode based on a control protocol.

11. The non-transitory medium of claim 8, comprising instructions to enable the detection of the hot-plug event and the transitioning of the target display from the standby mode to the active mode through a driver component associated with at least one of:
the processor of the source device, the processor of the target display and the target display.

12. The non-transitory medium of claim 11, comprising instructions compatible with the driver component being provided through at least one of: packaging the driver component with an operating system configured to execute on the source device and packaging the driver component with an application configured to execute on the source device.

13. The non-transitory medium of claim 10, further comprising instructions to periodically poll, through the at least one of the processor of the source device and the processor of the target display, the display interface for a status thereof to enable the detection of the hot-plug event.

14. A system comprising:
a display; and
a source device comprising a processor communicatively coupled to a memory, the processor being configured to execute instructions to: detect a hot-plug event indicating coupling of the display to the source device without shutting down both the source device and the display when the display is in a standby mode of operation thereof, and transition the display from the standby mode of operation to an active mode of operation thereof based on a control signal from the processor following the detection of the hot-plug event, and the active mode being associated with a higher power level than the standby mode.

15. The system of claim 14, wherein one of: the display is wirelessly coupled to the source device, and the display is coupled to the source device through wired means.

16. The system of claim 15, wherein when the display is coupled to the source device through the wired means, the processor is configured to execute instructions to:
utilize a control port of a display interface involved in the coupling to detect the hot-plug event, and
utilize another control port of the display interface to transition the display from the standby mode to the active mode based on a control protocol.

17. The system of claim 14, further comprising a driver component to enable the detection of the hot-plug event and the transitioning of the display from the standby mode to the active mode, the driver component being associated with at least one of:
the processor of the source device and the display.

18. The system of claim 17, wherein the driver component is provided through at least one of: packaging the driver component with an operating system configured to execute on the source device and packaging the driver component with an application configured to execute on the source device.

19. The system of claim 16, wherein at least one of:
the source device is one of a computing device and a mobile device,
the display is one of an LCD and a computing device including the LCD, and
the control protocol is CEC-based.

20. The system of claim 16, wherein the processor is configured to execute instructions to periodically poll the display interface for a status thereof to enable the detection of the hot-plug event.
